(19) United States
(12) Patent Application Publication
(10) Pub. No.: US 2008/0100075 A1
(43) Pub. Date: May 1, 2008

(54) SLIDING OVERHEAD RACK FOR PICKUP TRUCKS

(76) Inventor: Thomas E. DERECKTOR, Portsmouth, RI (US)

Correspondence Address: PILLSBURY WINTHROP SHAW PITTMAN, LLP, P.O. BOX 10500, MCLEAN, VA, 22102, US

(21) Appl. No.: 11/554,628

(22) Filed: Oct. 31, 2006

(51) Int. Cl. B60P 3/00

(52) U.S. Cl. 296/3

(57) ABSTRACT

An overhead rack for a pickup truck is provided, comprising a pair of mounts for connecting to respective sides of the pickup tuck; a cross-bar; and a pair of tubular upright posts, each of the posts supporting a respective end of the cross-bar and being mounted to a respective one of the pair of mounts; wherein a cross-section of each of the upright posts at its bottom end portion is elongated and has its long axis oriented in a first direction substantially parallel to the respective one of the pair of mounts, and the cross-section of each of the upright post at its top end portion is also elongated and has its long axis oriented in a second direction substantially parallel to that of the cross-bar, the first and second directions being generally perpendicular to one another; wherein each upright post also has a transitional portion extending between its top and bottom end portions, the transitional portion having a cross-section that transitions gradually and continuously between the bottom and top end portions.

### FIELD

The present invention relates to a sliding overhead rack for pickup trucks.

### BACKGROUND

Overhead racks are known for releasably and adjustably attaching articles to a vehicle, such as a pickup truck. The truck may be provided with at least two overhead racks for supporting articles in a level manner. Such articles can be skis, building supplies, lumber, ladders, bicycles, or the like. Each overhead rack comprises a pair of upright posts, a pair of mounts for mounting bottom ends of the posts to the bed sidewall, and a cross bar interconnecting upper ends of the posts. For example, see U.S. Pat. No. 5,494,327, herein incorporated by reference.

Typically, the upright posts generally are fabricated from an extruded tube of aluminum. The cross-section of each post is elongated (e.g., oval or rectangular) having a long axis and a short axis, but consistent along its length. The mounts are generally oriented along the length of the sidewalls of the bed of the pickup truck. The cross-bar, in contrast, is oriented above and generally perpendicular to the sidewalls of the bed of the pickup truck. When subject to bending moments, the elongated shape is generally stronger in the direction of its longer axis, and weaker in the direction of its short axis. In the prior art design, the posts are typically oriented with their long axes aligned to the mounts and the bed sidewalls. This provides for a stronger connection between the mounts and the post, and stronger bending resistance in the vehicle's fore/aft direction. However, the upper ends of the cross-bar are aligned with the short axes of the posts, and the resistance to bending from transverse loads from the cross-bar is not as strong in those areas.

It is known in the art to provide a corner brace support to provide added stability to the overhead rack; however, this requires added complexity and additional elements to be manufactured and assembled.

### SUMMARY

The invention provides an overhead rack for a pickup truck comprising: a pair of mounts for connecting respective sidewalls of the pickup truck; a generally horizontally extending cross-bar; and a pair of tubular upright posts, each of said posts supporting a respective end of said cross-bar and being mounted to a respective one of said pair of mounts; wherein a cross-section of each of said upright posts at its bottom end portion is elongated and has its long axis oriented in a first direction substantially parallel to the respective one of said pair of mounts, and the cross-section of each of said upright post at its top end portion is also elongated and has its long axis oriented in a second direction substantially parallel to that of the cross-bar, the first and second directions being generally perpendicular to one another. The rack may be of the type to which articles are secured, or it may be a roll bar type structure.

In an optional preferred embodiment, each upright post also has a transitional portion extending between its top and bottom end portions, the transitional portion having a cross-section that transitions gradually and continuously between the bottom and top end portions.

In a preferred embodiment, the mounts are slideably and releaseably connected to a pair of tracks mounted on respective sidewalls of the pickup truck.

Other objects, features, and advantages of one or more embodiments of the present invention will seem apparent from the following detailed description, and accompanying drawings, and the appended claims.

### BRIEF DESCRIPTION OF THE DRAWINGS

Embodiments of the present invention will now be disclosed, by way of example only, with reference to the accompanying schematic drawings in which corresponding reference symbols indicate corresponding parts, in which

FIG. 1 is a rear perspective view of a pick-up truck having a set of racks where the racks are shown in position and secured to the bed of a pick-up truck, according to the invention;

FIG. 2 is a rear perspective view of the rear sliding overhead rank of FIG. 1;

FIG. 3 is a rear perspective view of the front sliding overhead rack of FIG. 1;

FIG. 4 is an enlarged rear perspective view of the structural components on the right side of the rack of FIG. 2 mounted to the bed of a pick-up truck;

FIG. 5 is a front elevated view the structure illustrated in FIG. 4;

FIG. 6 is a right side profile view of the structure illustrated in FIG. 4;

FIG. 7 is a top cross-sectional view of FIG. 5, taken along line 7-7;

FIG. 8 is a top cross-sectional view of FIG. 5, taken along line 8-8; and

FIG. 9 is a top cross-sectional view of FIG. 5, taken along line 9-9.

### DETAILED DESCRIPTION

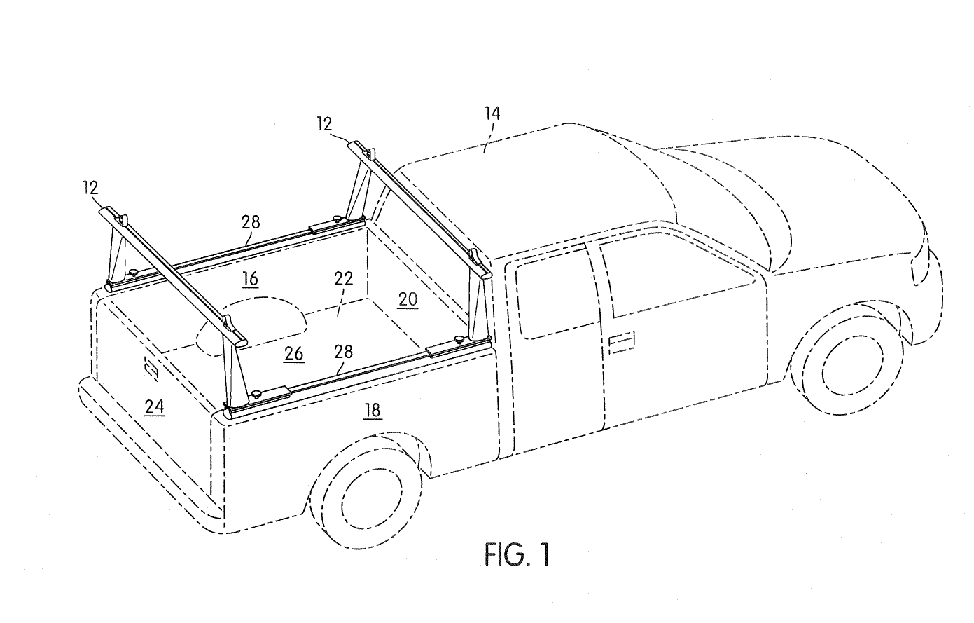

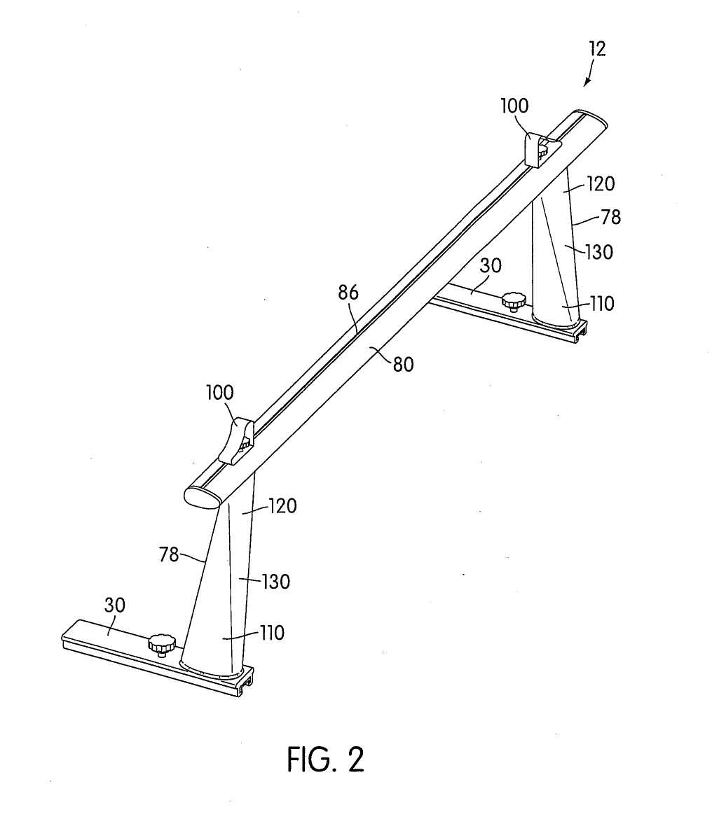

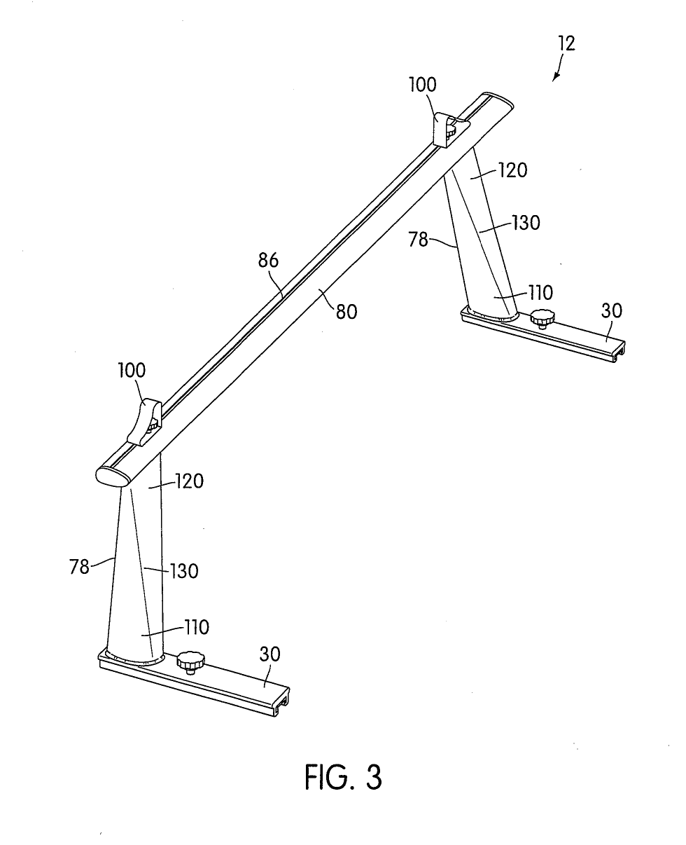

Referring now to the drawings, and more particularly to FIG. 1, a plurality of overhead racks, each indicated at 12, are releasably and adjustably connected to a pickup truck, indicated at 14. Preferably, the pickup truck 14 is of conventional design, having a pair of spaced-apart side walls 16, 18, a forward wall 20, a bottom wall 22, and a tailgate 24 which together define an open bed 26. The truck 14 may be provided with at least two overhead racks 12 for supporting articles in a level manner. However, it should be understood that the present invention can be adapted to any number of suitable uses and is not just limited to pickup trucks. FIG. 2 shows an enlarged view of the rear overheard rack of FIG. 1, while FIG. 3 shows an enlarged view of the front overhead rack of FIG. 1.

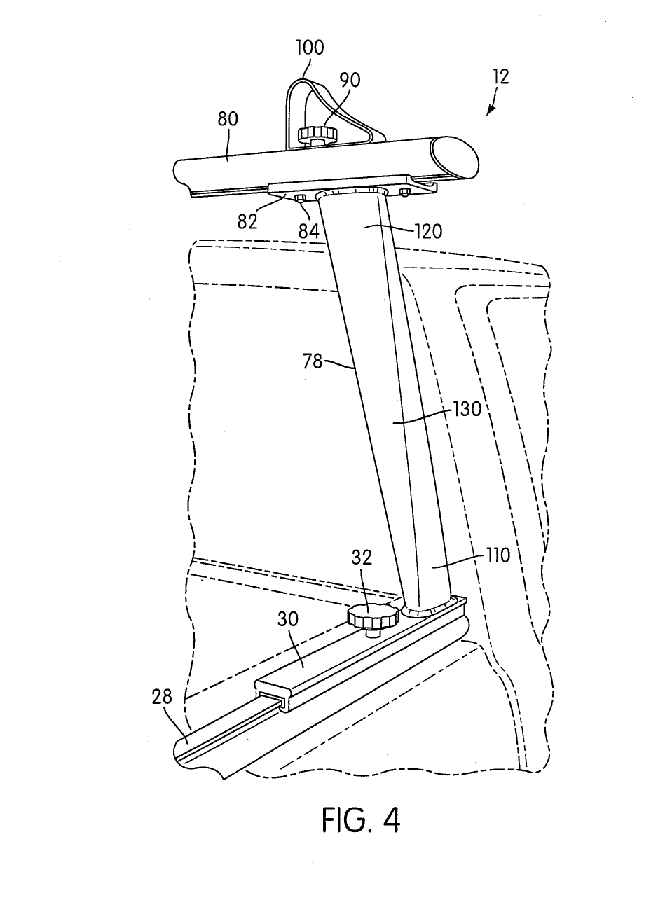

A plurality of mounts, each indicated at 30, connect the overheads racks 12 to the pickup truck 12. It will be appreciated that the mounts 30 may be directly mounted to the sidewall 16, 18 of the pickup truck. Preferably, a track, such as one of a pair of tracks each indicated at 28, is mounted on respective sides walls 16, 18 of the pickup truck 14, provides a slideable and releaseable connection for mount 30. As illustrated in FIG. 1, four sliding mounts 30 attach the two overhead racks 12 to the side wall 16, 18 of the pickup truck 14 in such a manner that each overhead rack 12 is adapted to slide along the length of the bed 26 of the truck independently of the other. Referring to FIG. 4, a knob or other suitable locking means, generally indicated 32, may be associated with each mount 30 for locking the overhead rack 12 into a desired position along the length of the bed 26, as disclosed in the above incorporated U.S. Pat. No. 5,494,327.

Turning now to FIGS. 2 and 3, each overhead rack 12, comprises a pair of tubular upright posts, each indicated at 78, being suitably attached (e.g., by welds, clamps, or threaded fasteners) to a respective mount 30 and cross-bar 80 interconnecting the upright posts 78. Preferably, each of the upright posts 78 includes a flange, indicated at 82, which is attached to the cross-bar 80 by nut and bolt fasteners indicated at 84 as shown in FIG. 4. This arrangement enables the user of the overhead rack 12 to completely breakdown the overhead rack 12 when it is no longer being used or needs to be transported. However, the upright posts 78 may be permanently attached to the cross-bar 80 by other means, e.g., welding.

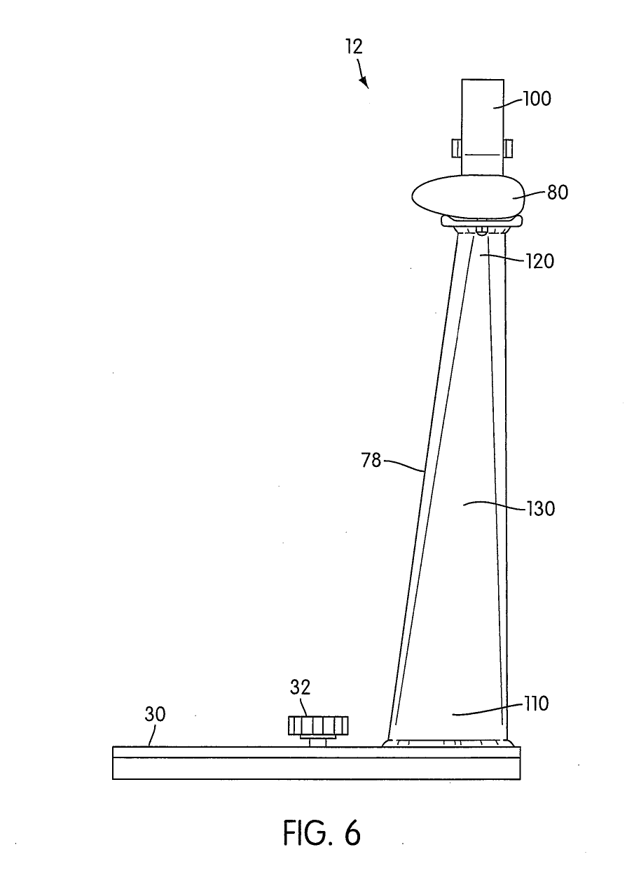

The cross-bar 80 is tubular in cross-section and has a channel 86 formed its top. Preferably, the cross-bar 80 is fabricated from an extruded tube of aluminum or aluminum alloy which has been found to be light-weight, easy to manufacture and strong in construction. As shown in FIG. 6, the cross-bar 80 preferably comprises an airfoil of a teardrop (or other aerodynamic) cross-section to reduce wind resistance and drag. The top channel 86 is configured to receive lateral detents 100 and/or other tie-down mechanisms (not shown) for securing articles. The detents 100 are designed for limiting lateral movement of articles, which are placed on the overhead racks. Similarly, the tie-down mechanisms enable a user to tie down objects. A knob or other suitable locking means, indicated at 90, may be associated with each detent 100, for adjustably positioning and locking the detent 100 into a desired position along the length of the channel 86, as disclosed in the above incorporated U.S. Pat. No. 5,494,327.

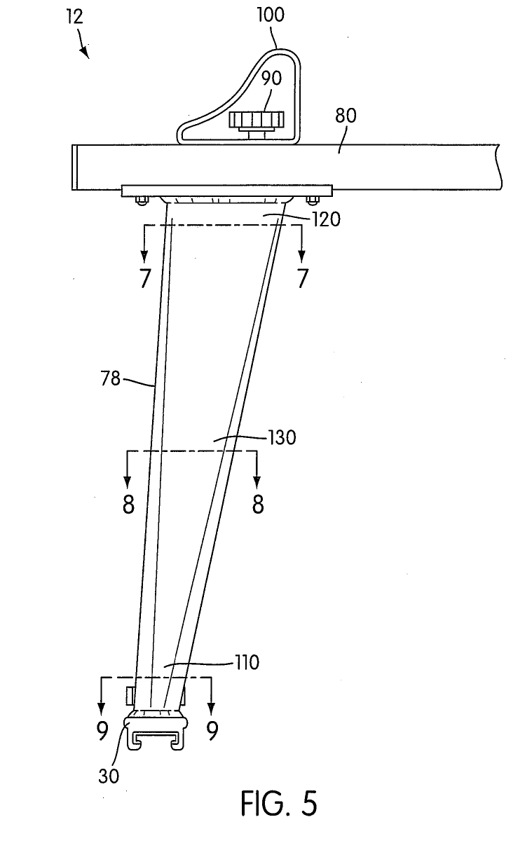

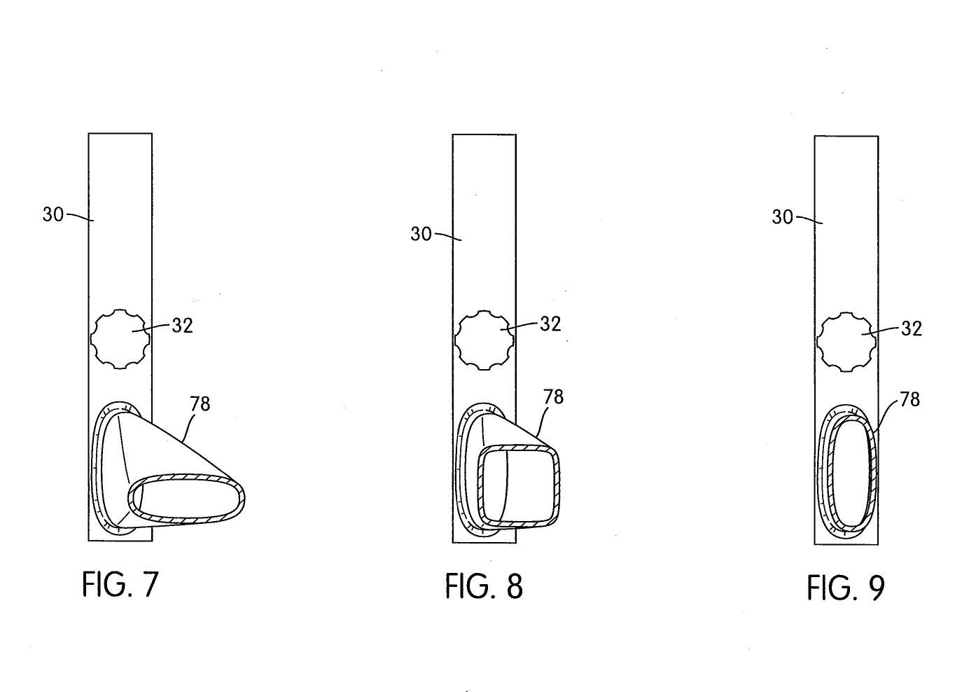

Each upright post 78 has a bottom end portion, indicated at 110, a top end portion, indicated at 120, and a transitional portion, indicated at 130, located between the bottom and top end portions 110, 120. The cross-sections of both the top and bottom end portions 110, 120 are elongated and both have a long axis and a short axis. Preferably, the cross-section shape is oval (see FIGS. 7 and 9); yet other elongated shapes having both long and short axes are envisioned such as an ellipse, egg, rectangle, or the like. Referring to FIG. 4, the top and bottom end portions 110, 120 are advantageously oriented in a direction substantially parallel to its respective mount 30 and cross-bar 80. FIG. 5, shows a front elevated view of the overhead rack 12 of FIG. 4, showing the top end portion 110 is oriented substantially parallel to the cross-bar 80. Similarly, FIG. 6 shows a right side profile view of the overhead rack 12 of FIG. 4, showing the bottom end portion 120 is oriented substantially parallel its respective mount 30.

FIG. 7, taken along line 7-7 in FIG. 5, shows the cross-section of the upright posts 78 right at its top end portion 120 is elongated and has its long axis oriented in a second direction substantially parallel to that of the cross-bar 80. FIG. 9, taken along line 9-9 in FIG. 5, shows the cross-section of the upright post 78 at its bottom end portion 110 is also elongated and has its long axis oriented in a first direction substantially parallel to its respective mount 30. FIG. 8, taken along line 8-8 in FIG. 5, shows the cross-section of the upright post 78 at its transitional portion 130 having a cross-section that transitions gradually and continuously between the bottom and top end portions of the upright post 78.

Upright post 78 may be fabricated from a hollow tubular member or other stock material of aluminum or aluminum alloy which has been found to be light-weight, easy to manufacture and strong in construction. Those skilled in the art will recognize and appreciate that other materials may similarly be used, such as steel, stainless steel, plastics, etc. One end of the tubular member may be inserted into a press (or other deforming machine) to form the top end portion 110 of the upright post 78 having an appropriately sized and oriented cross-section, for connection with an end of the cross-bar 78. The tubular member may then be turned approximately 90 degrees and the other end inserted into the press to form the bottom end portion 120 of the upright post 78 having an appropriately sized and oriented cross-section for connection with its respective mount 30. End portions 110, 120 may advantageously have different cross-section, shapes, and/or areas, as design requirements may require.

While the specific embodiments of the present invention have described above, it will be appreciated that the invention may be practices otherwise than described. The description is not intended to limit the invention.

1. An overhead rack for a vehicle comprising:
a pair of mounts for connecting to respective sidewalls of the vehicle;
a generally horizontally extending cross-bar; and
a pair of tubular upright posts having a bottom end portion, and a top end portion, each of said posts supporting a respective end of said cross-bar and being mounted to a respective one of said pair of mounts;
wherein a cross-section of each of said upright posts at the bottom end portion is elongated having a long axis oriented in a first direction substantially parallel to the respective one of said pair of mounts, and the cross-section of each of said upright posts at the top end portion is also elongated having a long axis oriented in a second direction substantially parallel to that of the cross-bar, the first and second directions being generally perpendicular to one another.

2. The overhead rack of claim 1, wherein each upright post also has a transitional portion extending between the top and bottom end portions, the transitional portion having a cross-section that transitions gradually and continuously between the bottom and top end portions.

3. The overhead rack of claim 1, wherein said pair of mounts are slideably and releasably connected to a par of tracks mountable on respective sides of the vehicle.

4. The overhead rack of claim 1, wherein said cross-bar comprises an airfoil.

5. The overhead rack of claim 1, wherein said pair of upright posts are made of aluminum or an aluminum alloy.

6. The overhead rack of claim 1, wherein said cross-bar further comprises a track and at least one slideable and releasable lateral detent, tie down mechanism, or combination thereof.

7. The overhead rack of claim 6, wherein said cross-bar comprises two lateral detents or two tie down mechanisms.

8. The overhead rack of claim 1, wherein each of said pair of upright posts comprises a mounting connection at each of the bottom and top end portions, and the cross-section of each of said pair of upright posts at said mounting connections are oval.

9. A vehicle comprising:
a pair of spaced-apart side walls, a forward wall, a bottom wall, and a tailgate which together define an open bed; and
at least one overhead rack, each overhead rack comprising:
a pair of mounts for connecting to respective sidewalls of the vehicle;
a generally horizontally extending cross-bar; and
a pair of tubular upright posts having a bottom end portion and a top end portion, each of said posts supporting a respective end of said cross-bar and being mounted to a respective one of said pair of mounts;
wherein a cross-section of each of said upright posts at the bottom end portion is elongated having a long axis oriented in a first direction substantially parallel to the respective one of said pair of mounts, and the cross-section of each of said upright posts at the top end portion is also elongated having a long axis oriented in a second direction substantially parallel to that of the cross-bar, the first and second directions being generally perpendicular to one another.

10. The vehicle of claim 9, wherein each upright post also has a transitional portion extending between the top and bottom end portions, the transitional portion having a cross-section that transitions gradually and continuously between the bottom and top end portions.

11. The overhead rack of claim 2, wherein each of said pair of upright posts comprises a mounting connection at each of the bottom and top end portions, and the cross-section of each of said pair of upright posts at said mounting connections are oval.

12. The overhead rack of claim 11, wherein a flange is attached to the top end portion of each of said pair of upright posts for mounting to the cross-bar.

13. The overhead rack of claim 12, wherein said mounting connections are welds.

14. The vehicle of claim 10, wherein each of said pair of upright posts comprises a mounting connection at each of the bottom and top end portions, and the cross-section of each of said pair of upright posts at said mounting connections are oval.

15. The vehicle of claim 14, wherein a flange is attached to the top end portion of each of said pair of upright posts for mounting to the cross-bar.

16. The vehicle of claim 15, wherein said mounting connections are welds.
